(19) United States
(12) Patent Application Publication
(10) Pub. No.: US 2024/0107398 A1
(43) Pub. Date: Mar. 28, 2024

(54) DETECTION AND MITIGATION FOR UPLINK DATA STALL

(71) Applicant: QUALCOMM Incorporated, San Diego, CA (US)

(72) Inventors: Jianqiang ZHANG, Beijing (CN); Arvind Vardarajan SANTHANAM, San Diego, CA (US); Jie MAO, Beijing (CN); Xiaochen CHEN, Beijing (CN); Jinglei TIAN, Shenzhen (CN); Ling LEI, Beijing (CN); Nan ZHANG, Beijing (CN); Qiang DENG, Shenzhen (CN); Zhanyi LIU, Beijing (CN)

(21) Appl. No.: 18/254,513

(22) PCT Filed: Jan. 9, 2021
(86) PCT No.: PCT/CN2021/070985

§ 371 Date: May 25, 2023

(51) Int. Cl. H04W 36/00; H04W 36/30

(52) U.S. Cl. CPC H04W 36/00837; H04W 36/30

(57) ABSTRACT

Various aspects of the present disclosure generally relate to wireless communication. In some aspects, a user equipment (UE) may determine that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput. The UE may transmit information identifying one or more adjusted measurement values based at least in part on the determination of the one or more threshold criteria. Numerous other aspects are described.

### FIELD OF THE DISCLOSURE

Aspects of the present disclosure generally relate to wireless communication and to techniques and apparatuses for detection and mitigation for uplink data stall.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and transmitting information identifying one or more adjusted measurement values based at least in part on the determination of the one or more threshold criteria.

In some aspects, a user equipment (UE) for wireless communication includes a memory; and one or more processors operatively coupled to the memory, the memory and the one or more processors configured to: determine that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and transmit information identifying one or more adjusted measurement values based at least in part on the determination of the one or more threshold criteria.

In some aspects, a non-transitory computer-readable medium storing a set of instructions for wireless communication includes one or more instructions that, when executed by one or more processors of a user equipment (UE), cause the UE to: determine that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and transmit information identifying one or more adjusted measurement values based at least in part on the determination of the one or more threshold criteria.

In some aspects, an apparatus for wireless communication includes means for determining that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and means for transmitting information identifying one or more adjusted measurement values based at least in part on the determination of the one or more threshold criteria.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIGS. 3A-3B are diagrams illustrating examples associated with detection and mitigation for uplink data stall, in accordance with various aspects of the present disclosure.

FIG. 4 is a diagram illustrating an example process associated with detection and mitigation for uplink data stall, in accordance with various aspects of the present disclosure.

FIGS. 5-6 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

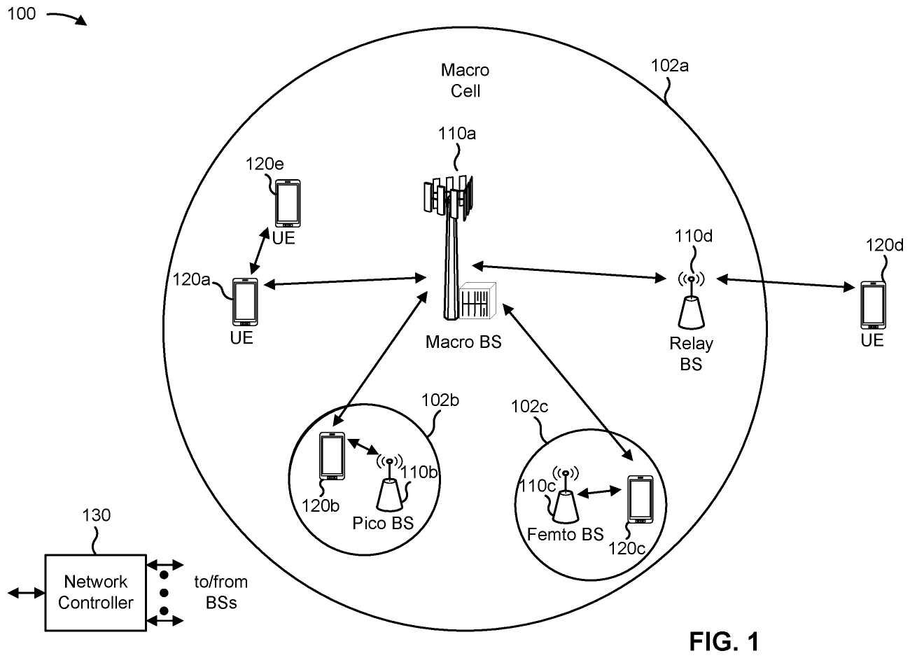

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

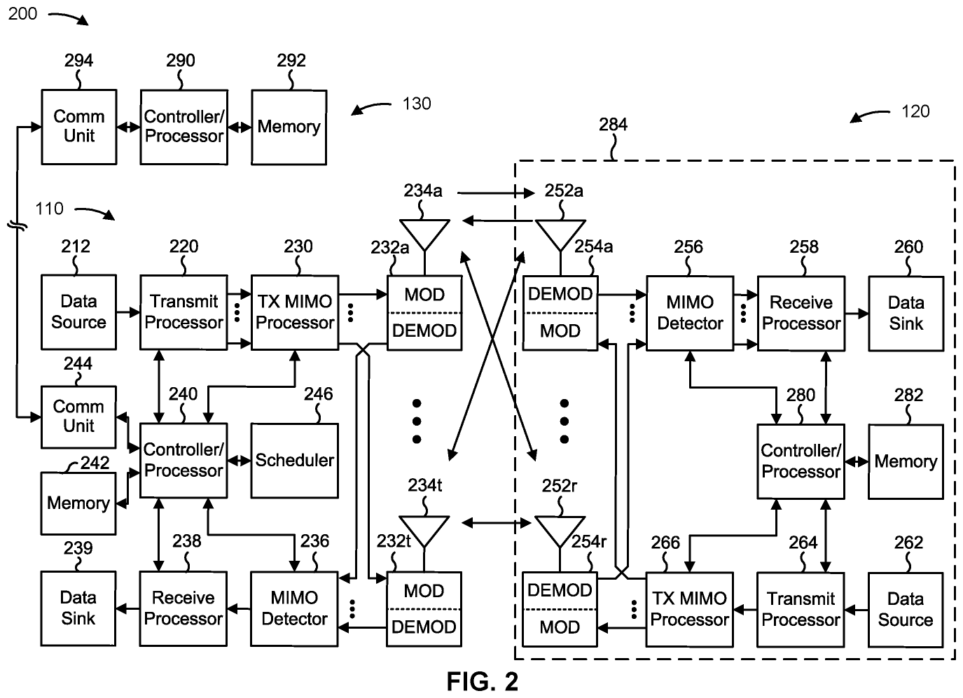

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

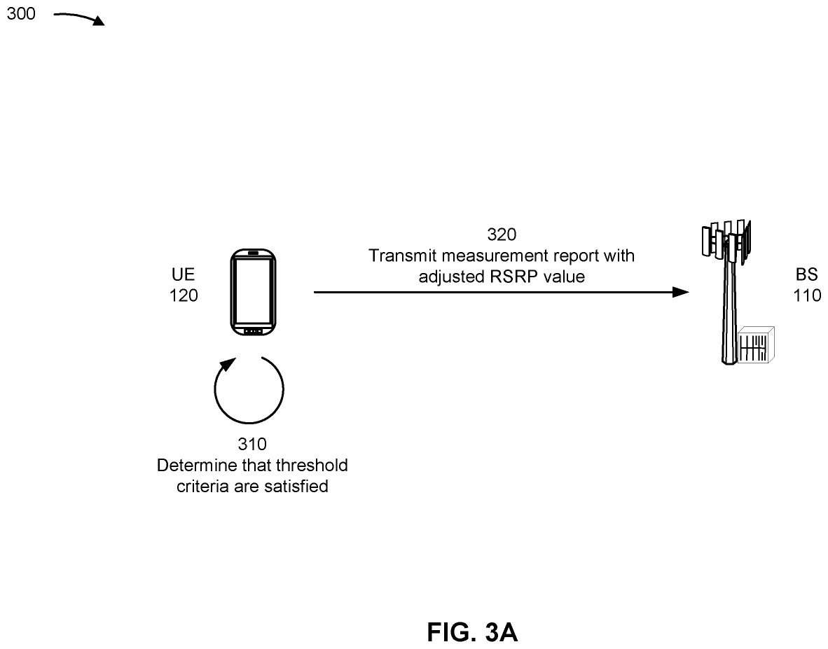

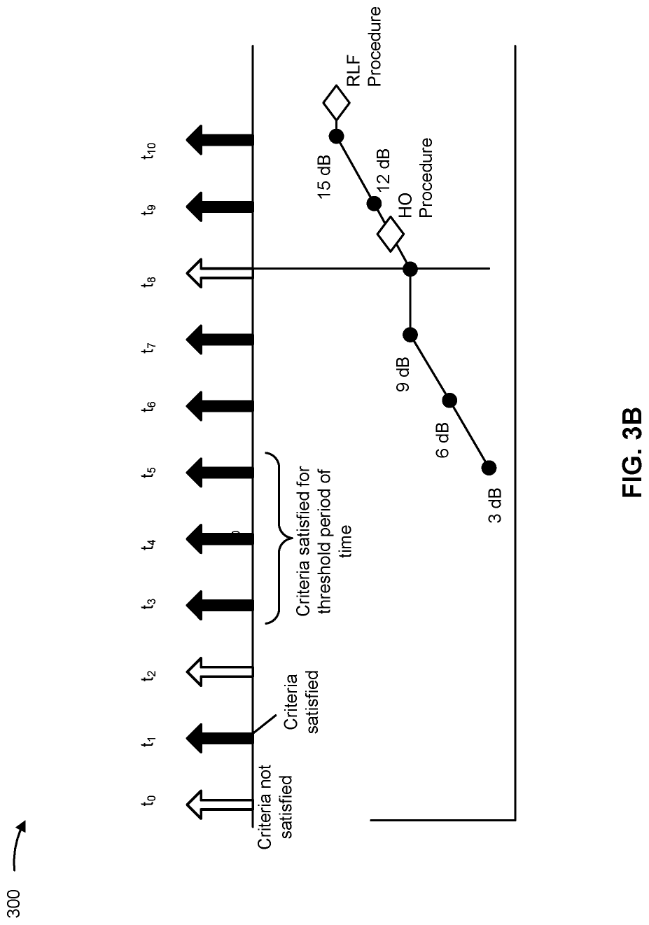

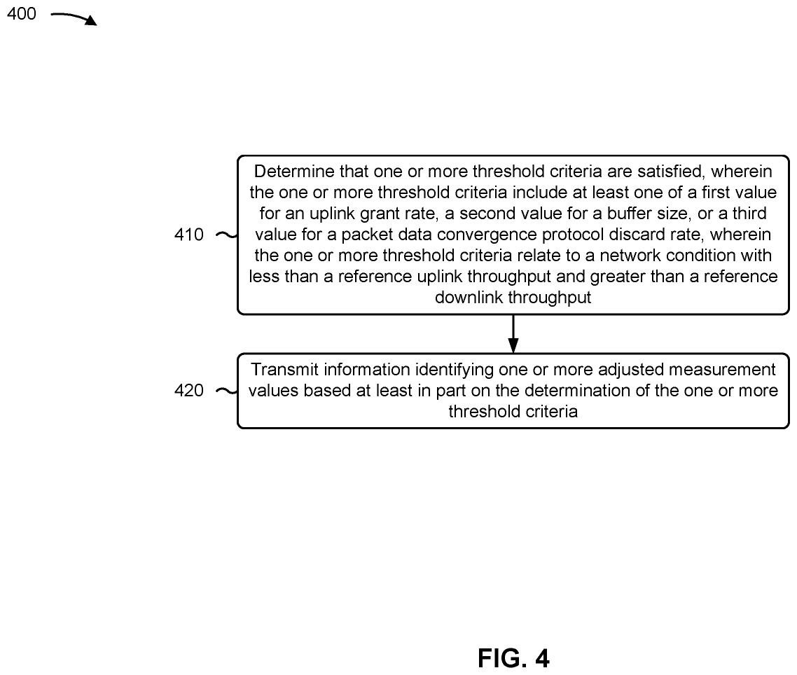

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3A-4.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3A-4.

Controller/processor 240 of base station 110, controller/processor 280 of UE 120, and/or any other component(s) of FIG. 2 may perform one or more techniques associated with detection and mitigation for uplink data stall, as described in more detail elsewhere herein. For example, controller/processor 240 of base station 110, controller/processor 280 of UE 120, and/or any other component(s) of FIG. 2 may perform or direct operations of, for example, process 400 of FIG. 4 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4 and/or other processes as described herein. In some aspects, executing instructions may include running the instructions, converting the instructions, compiling the instructions, and/or interpreting the instructions, among other examples.

In some aspects, the user equipment (UE) includes means for determining (e.g., using controller/processor 280, memory 282, or the like) that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; or means for transmitting (e.g., using controller/processor 280, transmit processor 264, TX MIMO processor 266, MOD 254, antenna 252, memory 282, or the like) information identifying one or more adjusted measurement values based at least in part on the determination of the one or more threshold criteria. The means for the user equipment (UE) to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the user equipment (UE) includes means for determining (e.g., using controller/processor 280, memory 282, or the like), based at least in part on one or more values associated with the one or more threshold criteria, a power headroom; or means for transmitting (e.g., using controller/processor 280, transmit processor 264, TX MIMO processor 266, MOD 254, antenna 252, memory 282, or the like) the information identifying the one or more adjusted measurement values based at least in part on the power headroom.

In some aspects, the user equipment (UE) includes means for transmitting (e.g., using controller/processor 280, transmit processor 264, TX MIMO processor 266, MOD 254, antenna 252, memory 282, or the like) the information identifying the one or more adjusted measurement values based at least in part on the one or more threshold criteria being satisfied for the threshold period of time.

In some aspects, the user equipment (UE) includes means for determining (e.g., using controller/processor 280, memory 282, or the like) that the first value satisfies a first corresponding threshold, that either the second value satisfies a second corresponding threshold or the third value satisfies a third corresponding threshold, that a reference signal received power value satisfies a reference signal received power threshold, and that a power headroom value satisfies a power headroom threshold; or means for classifying (e.g., using controller/processor 280, memory 282, or the like) a serving cell as a first type of cell.

In some aspects, the user equipment (UE) includes means for determining (e.g., using controller/processor 280, memory 282, or the like) that the serving cell is the first type of cell for a threshold period of time; or means for classifying (e.g., using controller/processor 280, memory 282, or the like) the serving cell as a second type of cell; or means for transmitting (e.g., using controller/processor 280, transmit processor 264, TX MIMO processor 266, MOD 254, antenna 252, memory 282, or the like) the information identifying the one or more adjusted measurement values based at least in part on classifying the serving cell as the second type of cell.

In some aspects, the user equipment (UE) includes means for performing (e.g., using controller/processor 280, transmit processor 264, TX MIMO processor 266, MOD 254, antenna 252, memory 282, DEMOD 254, MIMO detector 256, receive processor 258, or the like) a handover based at least in part on transmitting the information identifying the one or more adjust measurement values.

In some aspects, the user equipment (UE) includes means for triggering (e.g., using controller/processor 280, transmit processor 264, TX MIMO processor 266, MOD 254, antenna 252, memory 282, DEMOD 254, MIMO detector 256, receive processor 258, or the like) a radio link failure based at least in part on transmitting the information identifying the one or more adjusted measurement values.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

In some communications systems, an uplink data stall scenario may occur where a UE has a low uplink throughput (e.g., less than a threshold, such as less than 400 bytes per second (bytes/s)) on a particular cell. A low uplink throughput may result in excessive delays in data transfer or poor user experience, among other examples. Despite the low uplink throughput on the particular cell, the UE may experience relatively high downlink throughput (e.g., greater than a threshold uplink throughput) with a relatively low block error rate (BLER) (e.g., less than a threshold BLER).

In one example, this scenario may occur when the UE is receiving relatively few or small uplink grants even as a buffer status report (BSR) value increases. In another example, this scenario may occur when the BSR value is relatively low, but the UE is receiving relatively few or small uplink grants and a packet data convergence protocol (PDCP) discard rate is greater than a size of the uplink grants. After a period of time experiencing the aforementioned scenario, the UE may transfer from the particular cell to another cell, such as via a handover (HO) procedure or a radio link failure (RLF) procedure. However, a delay in triggering or initiating the HO procedure or RLF procedure may result in an excessive period of time with the aforementioned excessive delay in data transfer or poor user experience, among other examples.

Some aspects described herein enable detection and mitigation for uplink data stall. For example, a UE may determine that one or more threshold criteria are satisfied for a serving cell and may classify the serving cell as a problematic cell. In this case, the UE may apply a penalty to a reference signal received power (RSRP) reported in one or more measurement reports (MRs). For example, the UE may apply a penalty of between approximately 3 decibel (dB) and 15 dB penalty in an MR. In this case, based at least in part on applying the penalty, an amount of delay in the BS initiating a HO procedure or an RLF procedure is reduced, thereby reducing an amount of time to transfer the UE from the problematic cell to another cell. Based at least in part on reducing the amount of time to transfer the UE to another cell, the BS and the UE ensure a reduced delay in data transfer or an improved user experience, among other examples.

FIGS. 3A and 3B are diagrams illustrating an example 300 associated with detection and mitigation of uplink data stall, in accordance with various aspects of the present disclosure. As shown in FIG. 3A, example 300 includes communication between a BS 110 and a UE 120. In some aspects, BS 110 and UE 120 may be included in a wireless network, such as wireless network 100. BS 110 and UE 120 may communicate via a wireless access link, which may include an uplink and a downlink.

As further shown in FIG. 3A, and by reference number 310, UE 120 may determine that one or more threshold criteria are satisfied. For example, for a particular time interval (e.g., 2 seconds), UE 120 may determine a first condition of whether an uplink grant rate (e.g., a parameter ‘UL_GrantRate_bytes’), which represents a data rate in bytes of uplink grants over all logical channels and all uplink component carriers, satisfies a threshold value (e.g., a parameter Th_UL_Grant_lowerlimit), such as a threshold of 400 bytes/s. Additionally, or alternatively, UE 120 may determine a second condition of whether a buffer size (e.g., a parameter ‘Sum_BufferSize’), which represents a sum of a buffer across all logical channels, satisfies a threshold value (e.g., a parameter ‘Th_BufferSize_upperlimit’), such as a threshold of 20,000 bytes. Additionally, or alternatively, UE 120 may determine a third condition whether a PDCP discard rate (e.g., a parameter ‘UL_PdcpDiscard_bytes’), which represents a data rate in bytes of PDCP discard, satisfies a threshold (e.g., a threshold that is determined as a product of parameters ‘UL_GrantRate_bytes’ and ‘Ratio_Discard2Grant’).

Additionally, or alternatively, UE 120 may determine a fourth condition of whether a serving cell RSRP on a primary component carrier (PCC) satisfies a first threshold (e.g., a parameter ‘Th_lowest_RSRP’), such as a threshold of −117 dB-milliwatts (dBm) and whether a frequency tracking loop (FTL) signal to noise ratio (SNR) (FTLSNR) of the PCC satisfies a second threshold (e.g., a parameter ‘Th-lowest_FTLSNR’), such as a threshold of −6 dB. Additionally, or alternatively, UE 120 may determine a fifth condition of whether a power headroom (PHR) satisfies a threshold (e.g., a parameter ‘Th_PHR’), such as a threshold of 10 (e.g., an index value corresponding to a mapping of dB values to index values, as described below). For example, UE 120 may determine, for each PCC physical uplink shared channel (PUSCH), a filtered PUSCH PHR based at least in part on an equation:

Ph_avg(n)=Ph_avg(n−1)*0.9^{T/200ms}+ph(n)*(1−0.9^{T/200ms})

where Ph_avg represents an average PUSCH PHR determined based at least in part on a PUSCH n. In some aspects, UE 120 may map the PUSCH PHR to an index value. For example, UE 120 may convert the PUSCH PHR to a dB value and map the dB value to an index based at least in part on a set mapping, such as based at least in part on Table 9.1.8.4-1 in 3GPP Technical Specification (TS) 36.133, Release 17, Version 17.0.0. Additionally, or alternatively, UE 120 may determine the PHR based at least in part on a different PHR calculation procedure. Although some aspects are described in terms of determinations performed for a serving cell, as described below, UE 120 may perform the determinations described herein with regard to another cell, such as a neighbor cell.

In some aspects, UE 120 may evaluate one or more conditions to classify a serving cell. For example, UE 120 may determine whether the first condition is satisfied; and at least one of the second condition or the third condition is satisfied; and the fourth condition is satisfied; and the fifth condition is satisfied. In this case, UE 120 may classify the serving cell as a first type of cell, which may be termed a ‘doubtful cell’. As an example, as shown in FIG. 3B, at a first time, to, a set of criteria representing the aforementioned evaluation of the first through fifth conditions are not satisfied, but at a second time, ti, the set of criteria are satisfied and a serving cell is classified as a doubtful cell. In some aspects, UE 120 may classify the serving cell as a second type of cell, which may be termed a ‘problematic cell’ based at least in part on the set of criteria being satisfied for a threshold quantity of time intervals (e.g., a parameter, ‘N_confirm’), such as a threshold of 3 consecutive time intervals). For example, as shown in FIG. 3B, UE 120 may determine that the set of criteria are satisfied for time intervals t₃ through t₅ and may determine to classify the serving cell as a problematic cell. In some aspects, the threshold quantity of time intervals, N_confirm, may be based at least in part on a timestamp of when the serving cell was classified as a problematic cell. For example, if UE 120 determines that the serving cell is already added to a data structure storing information identifying problematic cells, as described below, and a timestamp for when the serving cell was added is within a threshold time interval, such as 2 hours, UE 120 may configure the threshold quantity of time intervals N_confirm as equal to N_confirm/2. Although some aspects are described in terms of a particular set of conditions, a particular combination of conditions, or a particular set of thresholds, among other examples, other parameters, conditions, combinations of conditions, or threshold are possible.

In some aspects, UE 120 may store information regarding classifying the serving cell as a problematic cell. For example, UE 120 may store information identifying an evolved universal mobile telecommunications system (UMTS) terrestrial radio access (E-UTRA) absolute radio frequency channel number (EARFCN), a physical layer cell identity (PCI), a timestamp representing when the serving cell was classified as a problematic cell, a flag indicating that the serving cell is currently classified as a problematic cell (e.g., which UE 120 may update if the serving cell does not satisfy the set of criteria at a future time interval, such as after a parameter ‘ T-_defavor’, which may be 5 minutes, is satisfied), or a penalty value, among other examples. The penalty value may represent an adjustment to an RSRP that is to be reported in a measurement report to enable triggering of an HO or RLF procedure in a reduced amount of time, as described above. For example, UE 120 may apply a 3 dB penalty value for each time interval in which the serving cell is classified as a problematic cell (e.g., a 3 dB penalty at t₅, a 6 dB penalty at t₇, a 12 dB penalty at t₉, or a 15 dB penalty at t₁₀, among other examples). In some aspects, when incrementing the penalty (e.g., at t₇ relative to t₅), UE 120 may increment the penalty as a smaller value of the current penalty plus a step size (e.g., 3 dB) or a maximum penalty value (e.g., a parameter RSRP_dec_upperlimit), which may be 15 dB. When UE 120 updates the penalty value, UE 120 may update a timer for classifying whether the serving cell is a problematic cell. In some aspects, UE 120 may update a timestamp in a database of when the serving cell was classified as a problematic cell.

As further shown in FIG. 3A, and by reference number 320, UE 120 may transmit a measurement report with an adjusted RSRP value. For example, UE 120 may transmit the measurement report with a current penalty value applied to an RSRP value of a cell, such as a serving cell or a neighbor cell, among other examples, as described in more detail below. In this case, BS 110 may communicate with UE 120 to trigger an HO procedure, as shown in FIG. 3B at t₈. If the HO procedure does not occur or is unsuccessful, UE 120 may continue to apply greater penalty values to subsequent measurement reports until a threshold is satisfied and BS 110 communicates with UE 120 to initiate an RLF procedure, as shown in FIG. 3B at t₁₀. In some aspects, UE 120 may perform a cell reselection. For example, when a timer associated with classification as a problematic cell is running, UE 120 may decrease an S value or rank for the serving cell, which may trigger a cell reselection at an earlier time than if no problematic cell determination is performed. In some aspects, if no intra-frequency neighbor cells are detected and no inter-frequency LTE measurement objects are configured (or if a best neighbor cell has an RSRP that is less than the serving cell RSRP by a threshold amount, such as a parameter ‘RSRP_dec_upperlimit’, which may be a threshold of 15 dB), the penalty may be set to RSRP_dec_upperlimit, the serving cell may be barred for a threshold period of time (e.g., 1 second), and an RLF procedure may be triggered.

In some aspects, UE 120 may apply the penalty to a particular RSRP value in a measurement report, such as based at least in part on which cells are classified as problematic in, for example, a data structure. For example, UE 120 may determine that the serving cell is classified as problematic and that a neighbor cell is not classified as problematic. Additionally, or alternatively, UE 120 may determine whether a neighbor cell is available with an RSRP of greater than Th_lowest_RSRP). In this case, for types A1, A3, or A5 measurement reports, UE 120 may decrease a serving cell RSRP for a PCC by the penalty value. In another example, UE 120 may determine that the serving cell is not a problematic cell, but that a neighbor cell is a problematic cell. In this case, when a serving cell RSRP for a PCC is greater than Th_lowest_RSRP and the serving cell FTLSNR is greater than Th_lowest_FTLSNR, UE 120 may decrease a neighbor cell RSRP by a penalty value (e.g., for a type A3, A4, or A5 measurement report). In another example, UE 120 may determine that both the serving cell and the neighbor cell are problematic cells. In this case, both the serving cell and neighbor cell have RSRPs for respective PCCs that satisfy Th_lowest_RSRP and FTL SNRs that satisfy-Th_lowest_FTLSNR, and UE 120 may decrease respective RSRP values by respective penalties for both cells (e.g., for a type A3, A4, or A5 measurement report).

As indicated above, FIGS. 3A and 3B is provided as an example. Other examples may differ from what is described with respect to FIGS. 3A and 3B.

FIG. 4 is a diagram illustrating an example process 400 performed, for example, by a user equipment (UE), in accordance with various aspects of the present disclosure. Example process 400 is an example where the UE (e.g., UE 120) performs operations associated with detection and mitigation for uplink data stall.

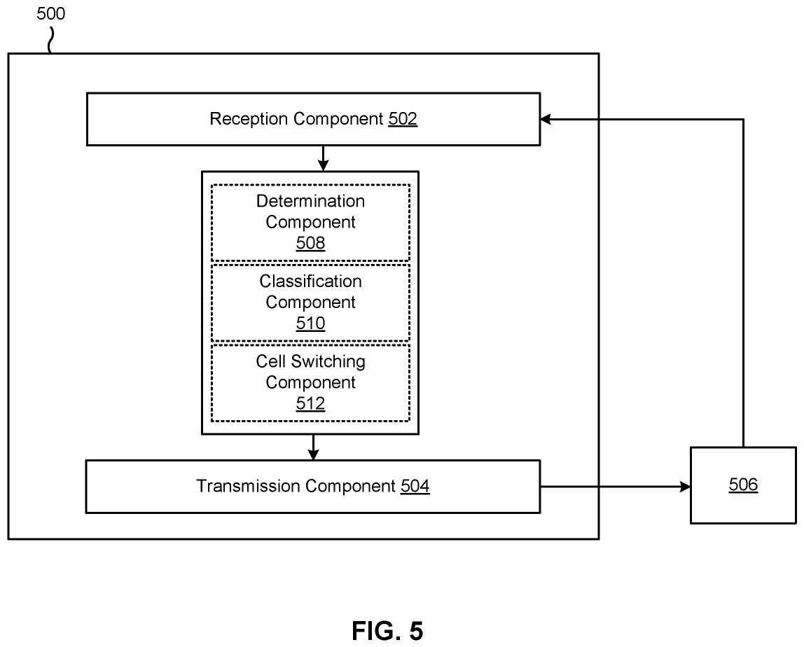

As shown in FIG. 4, in some aspects, process 400 may include determining that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput (block 410). For example, the UE (e.g., using determination component 508, depicted in FIG. 5) may determine that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput, as described above, for example, with reference to FIGS. 3A and 3B.

As further shown in FIG. 4, in some aspects, process 400 may include transmitting information identifying one or more adjusted measurement values based at least in part on the determination of the one or more threshold criteria (block 420). For example, the UE (e.g., using transmission component 504, depicted in FIG. 5) may transmit information identifying one or more adjusted measurement values based at least in part on the determination of the one or more threshold criteria, as described above, for example, with reference to FIGS. 3A and 3B.

Process 400 may include additional aspects, such as any single aspect or any combination of aspects described below and/or in connection with one or more other processes described elsewhere herein.

In a first aspect, process 400 includes determining, based at least in part on one or more values associated with the one or more threshold criteria, a power headroom, and wherein transmitting the information identifying the one or more adjusted measurement values comprises transmitting the information identifying the one or more adjusted measurement values based at least in part on the power headroom.

In a second aspect, alone or in combination with the first aspect, the one or more threshold criteria are satisfied for a threshold period of time, and wherein transmitting the information identifying the one or more adjusted measurement values comprises transmitting the information identifying the one or more adjusted measurement values based at least in part on the one or more threshold criteria being satisfied for the threshold period of time.

In a third aspect, alone or in combination with one or more of the first and second aspects, process 400 includes determining that a serving cell is a first type of cell based at least in part on at least one of: the first value satisfying a first corresponding threshold, either the second value satisfying a second corresponding threshold or the third value satisfying a third corresponding threshold, a reference signal received power value satisfying a reference signal received power threshold, a power headroom value satisfying a power headroom threshold, or any combination thereof; and classifying the serving cell as the first type of cell based at least in part on the determination that the serving cell is the first type of cell.

In a fourth aspect, alone or in combination with one or more of the first through third aspects, process 400 includes determining that the serving cell is the first type of cell for a threshold period of time, and classifying the serving cell as a second type of cell based at least in part on the determination that the serving cell is the first type of cell for the threshold period of time, and wherein transmitting the information identifying the one or more adjusted measurement values comprises transmitting the information identifying the one or more adjusted measurement values based at least in part on classifying the serving cell as the second type of cell.

In a fifth aspect, alone or in combination with one or more of the first through fourth aspects, the one or more adjusted measurement values are derived by applying a penalty to a reference signal received power configuration.

In a sixth aspect, alone or in combination with one or more of the first through fifth aspects, process 400 includes performing a handover based at least in part on transmitting the information identifying the one or more adjust measurement values.

In a seventh aspect, alone or in combination with one or more of the first through sixth aspects, process 400 includes triggering a radio link failure based at least in part on transmitting the information identifying the one or more adjusted measurement values.

In an eighth aspect, alone or in combination with one or more of the first through seventh aspects, the one or more adjusted measurement values apply to at least one of a serving cell or a neighbor cell.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a block diagram of an example apparatus 500 for wireless communication. The apparatus 500 may be a UE, or a UE may include the apparatus 500. In some aspects, the apparatus 500 includes a reception component 502 and a transmission component 504, which may be in communication with one another (for example, via one or more buses and/or one or more other components). As shown, the apparatus 500 may communicate with another apparatus 506 (such as a UE, a base station, or another wireless communication device) using the reception component 502 and the transmission component 504. As further shown, the apparatus 500 may include one or more of a determination component 508, a classification component 510, or a cell switching component 512, among other examples.

In some aspects, the apparatus 500 may be configured to perform one or more operations described herein in connection with FIGS. 3A-3B. Additionally, or alternatively, the apparatus 500 may be configured to perform one or more processes described herein, such as process 400 of FIG. 4. In some aspects, the apparatus 500 and/or one or more components shown in FIG. 5 may include one or more components of the UE described above in connection with FIG. 2. Additionally, or alternatively, one or more components shown in FIG. 5 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 502 may receive communications, such as reference signals, control information, data communications, or a combination thereof, from the apparatus 506. The reception component 502 may provide received communications to one or more other components of the apparatus 500. In some aspects, the reception component 502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 506. In some aspects, the reception component 502 may include one or more antennas, a demodulator, a MIMO detector, a receive processor, a controller/processor, a memory, or a combination thereof, of the UE described above in connection with FIG. 2.

The transmission component 504 may transmit communications, such as reference signals, control information, data communications, or a combination thereof, to the apparatus 506. In some aspects, one or more other components of the apparatus 506 may generate communications and may provide the generated communications to the transmission component 504 for transmission to the apparatus 506. In some aspects, the transmission component 504 may perform signal processing on the generated communications (such as filtering, amplification, modulation, digital-to-analog conversion, multiplexing, interleaving, mapping, or encoding, among other examples), and may transmit the processed signals to the apparatus 506. In some aspects, the transmission component 504 may include one or more antennas, a modulator, a transmit MIMO processor, a transmit processor, a controller/processor, a memory, or a combination thereof, of the UE described above in connection with FIG. 2. In some aspects, the transmission component 504 may be co-located with the reception component 502 in a transceiver.

The determination component 508 may determine that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput. The transmission component 504 may transmit information identifying one or more adjusted measurement values based at least in part on the determination of the one or more threshold criteria.

The determination component 508 may determine, based at least in part on one or more values associated with the one or more threshold criteria, a power headroom.

The determination component 508 may determine that the first value satisfies a first corresponding threshold, that either the second value satisfies a second corresponding threshold or the third value satisfies a third corresponding threshold, that a reference signal received power value satisfies a reference signal received power threshold, and that a power headroom value satisfies a power headroom threshold.

The classification component 510 may classify a serving cell as a first type of cell.

The determination component 508 may determine that the serving cell is the first type of cell for a threshold period of time.

The classification component 510 may classify the serving cell as a second type of cell.

The cell switching component 512 may communicate with the apparatus 506 to perform a handover based at least in part on transmitting the information identifying the one or more adjust measurement values.

The cell switching component 512 may trigger a radio link failure based at least in part on transmitting the information identifying the one or more adjusted measurement values.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

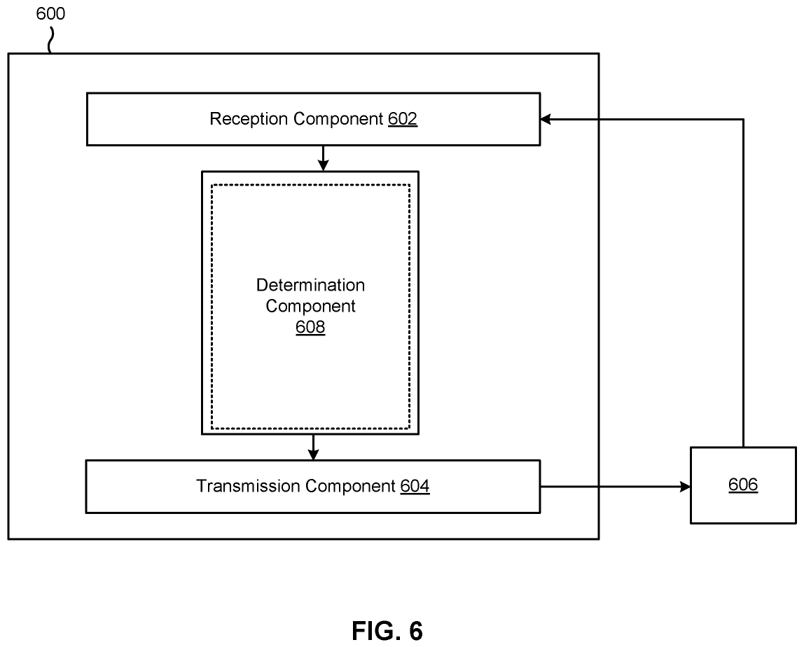

FIG. 6 is a block diagram of an example apparatus 600 for wireless communication. The apparatus 600 may be a BS, or a BS may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a determination component 608, among other examples.

In some aspects, the apparatus 600 may be configured to perform one or more operations described herein in connection with FIGS. 3A-3B. Additionally, or alternatively, the apparatus 600 may be configured to perform one or more processes described herein. In some aspects, the apparatus 600 and/or one or more components shown in FIG. 6 may include one or more components of the BS described above in connection with FIG. 2. Additionally, or alternatively, one or more components shown in FIG. 6 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the BS described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the BS described above in connection with FIG. 2. In some aspects, the transmission component 604 may be co-located with the reception component 602 in a transceiver.

The determination component 608 may determine whether to transfer the apparatus 606 from a first cell to a second cell based at least in part on a received measurement report, which may include an adjusted RSRP value, as described above.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some aspects of the present disclosure:

Aspect 1: A method of wireless communication performed by a user equipment (UE), comprising: determining that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and transmitting information identifying one or more adjusted measurement values based at least in part on the determination of the one or more threshold criteria.

Aspect 2: The method of aspect 1, further comprising: determining, based at least in part on one or more values associated with the one or more threshold criteria, a power headroom; and wherein transmitting the information identifying the one or more adjusted measurement values comprises: transmitting the information identifying the one or more adjusted measurement values based at least in part on the power headroom. wherein transmitting the information identifying the one or more adjusted measurement values comprises: transmitting the information identifying the one or more adjusted measurement values based at least in part on the power headroom.

Aspect 3: The method of any of aspects 1 to 2, wherein the one or more threshold criteria are satisfied for a threshold period of time; and wherein transmitting the information identifying the one or more adjusted measurement values comprises: transmitting the information identifying the one or more adjusted measurement values based at least in part on the one or more threshold criteria being satisfied for the threshold period of time.

Aspect 4: The method of any of aspects 1 to 3, further comprising: determining that a serving cell is a first type of cell based at least in part on at least one of: the first value satisfying a first corresponding threshold, either the second value satisfying a second corresponding threshold or the third value satisfying a third corresponding threshold, a reference signal received power value satisfying a reference signal received power threshold, a power headroom value satisfying a power headroom threshold, or any combination thereof; and classifying the serving cell as the first type of cell based at least in part on the determination that the serving cell is the first type of cell.

Aspect 5: The method of aspect 4, further comprising: determining that the serving cell is the first type of cell for a threshold period of time; and classifying the serving cell as a second type of cell based at least in part on the determination that the serving cell is the first type of cell for the threshold period of time; and wherein transmitting the information identifying the one or more adjusted measurement values comprises: transmitting the information identifying the one or more adjusted measurement values based at least in part on classifying the serving cell as the second type of cell. wherein transmitting the information identifying the one or more adjusted measurement values comprises: transmitting the information identifying the one or more adjusted measurement values based at least in part on classifying the serving cell as the second type of cell.

Aspect 6: The method of any of aspects 1 to 5, wherein the one or more adjusted measurement values are derived by applying a penalty to a reference signal received power configuration.

Aspect 7: The method of any of aspects 1 to 6, further comprising: performing a handover based at least in part on transmitting the information identifying the one or more adjust measurement values.

Aspect 8: The method of any of aspects 1 to 7, further comprising: triggering a radio link failure based at least in part on transmitting the information identifying the one or more adjusted measurement values.

Aspect 9: The method of any of aspects 1 to 8, wherein the one or more adjusted measurement values apply to at least one of a serving cell or a neighbor cell.

Aspect 10: An apparatus for wireless communication at a device, comprising a processor; memory coupled with the processor; and instructions stored in the memory and executable by the processor to cause the apparatus to perform the method of one or more aspects of aspects 1-9.

Aspect 11: A device for wireless communication, comprising a memory and one or more processors coupled to the memory, the memory and the one or more processors configured to perform the method of one or more aspects of aspects 1-9.

Aspect 12: An apparatus for wireless communication, comprising at least one means for performing the method of one or more aspects of aspects 1-9.

Aspect 13: A non-transitory computer-readable medium storing code for wireless communication, the code comprising instructions executable by a processor to perform the method of one or more aspects of aspects 1-9.

Aspect 14: A non-transitory computer-readable medium storing a set of instructions for wireless communication, the set of instructions comprising one or more instructions that, when executed by one or more processors of a device, cause the device to perform the method of one or more aspects of aspects 1-9.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors operatively coupled to the one or more memories, the one or more memories and the one or more processors configured to:
determine that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and
transmit information identifying one or more adjusted measurement values based at least in part on the determination of the one or more threshold criteria.

2. The UE of claim 1, wherein the one or more processors are further configured to:
determine, based at least in part on one or more values associated with the one or more threshold criteria, a power headroom; and
wherein the one or more processors, when transmitting the information identifying the one or more adjusted measurement values, are configured to:
transmit the information identifying the one or more adjusted measurement values based at least in part on the power headroom.

3. The UE of claim 1, wherein the one or more threshold criteria are satisfied for a threshold period of time; and
wherein the one or more processors, when transmitting the information identifying the one or more adjusted measurement values, are configured to:
transmit the information identifying the one or more adjusted measurement values based at least in part on the one or more threshold criteria being satisfied for the threshold period of time.

4. The UE of claim 1, wherein the one or more processors are further configured to:
determine that a serving cell is a first type of cell based at least in part on at least one of:
the first value satisfying a first corresponding threshold,
either the second value satisfying a second corresponding threshold or the third value satisfying a third corresponding threshold,
a reference signal received power value satisfying a reference signal received power threshold,
a power headroom value satisfying a power headroom threshold, or
any combination thereof; and
classify the serving cell as the first type of cell based at least in part on the determination that the serving cell is the first type of cell.

5. The UE of claim 4, wherein the one or more processors are further configured to:
determine that the serving cell is the first type of cell for a threshold period of time; and
classify the serving cell as a second type of cell based on the determination that the serving cell is the first type of cell for the threshold period of time; and
wherein the one or more processors, when transmitting the information identifying the one or more adjusted measurement values, are configured to:
transmit the information identifying the one or more adjusted measurement values based at least in part on classifying the serving cell as the second type of cell.

6. The UE of claim 1, wherein the one or more adjusted measurement values are derived by applying a penalty to a reference signal received power configuration.

7. The UE of claim 1, wherein the one or more processors are further configured to:
perform a handover based at least in part on transmitting the information identifying the one or more adjusted measurement values.

8. The UE of claim 1, wherein the one or more processors are further configured to:
trigger a radio link failure based at least in part on transmitting the information identifying the one or more adjusted measurement values.

9. The UE of claim 1, wherein the one or more adjusted measurement values apply to at least one of a serving cell or a neighbor cell.

10. A method of wireless communication performed by a user equipment (UE), comprising:
determining that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and
transmitting information identifying one or more adjusted measurement values based at least in part on the determination of the one or more threshold criteria.

11. The method of claim 10, further comprising:
determining, based at least in part on one or more values associated with the one or more threshold criteria, a power headroom; and
wherein transmitting the information identifying the one or more adjusted measurement values comprises:
transmitting the information identifying the one or more adjusted measurement values based at least in part on the power headroom.

12. The method of claim 10, wherein the one or more threshold criteria are satisfied for a threshold period of time; and
wherein transmitting the information identifying the one or more adjusted measurement values comprises:
transmitting the information identifying the one or more adjusted measurement values based at least in part on the one or more threshold criteria being satisfied for the threshold period of time.

13. The method of claim 10, wherein the one or more processors are further configured to:
determine that a serving cell is a first type of cell based at least in part on at least one of:
the first value satisfying a first corresponding threshold,
either the second value satisfying a second corresponding threshold or the third value satisfying a third corresponding threshold,
a reference signal received power value satisfying a reference signal received power threshold,
a power headroom value satisfying a power headroom threshold, or
any combination thereof; and
classify the serving cell as the first type of cell based at least in part on the determination that the serving cell is the first type of cell.

14. The method of claim 13, further comprising:
determining that the serving cell is the first type of cell for a threshold period of time; and
classifying the serving cell as a second type of cell based at least in part on the determination that the serving cell is the first type of cell for the threshold period of time; and
wherein transmitting the information identifying the one or more adjusted measurement values comprises:
transmitting the information identifying the one or more adjusted measurement values based at least in part on classifying the serving cell as the second type of cell.

15. The method of claim 10, wherein the one or more adjusted measurement values are derived by applying a penalty to a reference signal received power configuration.

16. The method of claim 10, further comprising:
performing a handover based at least in part on transmitting the information identifying the one or more adjust measurement values.

17. The method of claim 10, further comprising:
triggering a radio link failure based at least in part on transmitting the information identifying the one or more adjusted measurement values.

18. The method of claim 10, wherein the one or more adjusted measurement values apply to at least one of a serving cell or a neighbor cell.

19. A non-transitory computer-readable medium storing a set of instructions for wireless communication, the set of instructions comprising:
one or more instructions that, when executed by one or more processors of a user equipment (UE), cause the UE to:
determine that one or more threshold criteria are satisfied, wherein the one or more threshold criteria include at least one of a first value for an uplink grant rate, a second value for a buffer size, or a third value for a packet data convergence protocol discard rate, wherein the threshold relates to a network condition with less than a reference uplink throughput and greater than a reference downlink throughput; and
transmit information identifying one or more adjusted measurement values based at least in part on the determination of the one or more threshold criteria.

20. The non-transitory computer-readable medium of claim 19, wherein the one or more instructions further cause the UE to:
determine, based at least in part on one or more values associated with the one or more threshold criteria, a power headroom; and
wherein the one or more instructions, that cause the UE to transmit the information identifying the one or more adjusted measurement values, cause the UE to:
transmit the information identifying the one or more adjusted measurement values based at least in part on the power headroom.

21. The non-transitory computer-readable medium of claim 19, wherein the one or more threshold criteria are satisfied for a threshold period of time; and
wherein the one or more instructions, that cause the UE to transmit the information identifying the one or more adjusted measurement values, cause the UE to:
transmit the information identifying the one or more adjusted measurement values based at least in part on the one or more threshold criteria being satisfied for the threshold period of time.

22. The non-transitory computer-readable medium of claim 19, wherein the one or more instructions further cause the UE to:
determine that a serving cell is a first type of cell based at least in part on at least one of:
the first value satisfying a first corresponding threshold,
either the second value satisfying a second corresponding threshold or the third value satisfying a third corresponding threshold,
a reference signal received power value satisfying a reference signal received power threshold,
a power headroom value satisfying a power headroom threshold, or
any combination thereof; and
classify the serving cell as the first type of cell based at least in part on the determination that the serving cell is the first type of cell.

23. The non-transitory computer-readable medium of claim 22, wherein the one or more instructions further cause the UE to:
determine that the serving cell is the first type of cell for a threshold period of time; and
classify the serving cell as a second type of cell based at least in part on the determination that the serving cell is the first type of cell for the threshold period of time; and
wherein the one or more instructions, that cause the UE to transmit the information identifying the one or more adjusted measurement values, cause the UE to:
transmit the information identifying the one or more adjusted measurement values based at least in part on classifying the serving cell as the second type of cell.

24. The non-transitory computer-readable medium of claim 19, wherein the one or more adjusted measurement values are derived by applying a penalty to a reference signal received power configuration.

25. The non-transitory computer-readable medium of claim 19, wherein the one or more instructions further cause the UE to:
perform a handover based at least in part on transmitting the information identifying the one or more adjust measurement values.

26. The non-transitory computer-readable medium of claim 19, wherein the one or more instructions further cause the UE to:
trigger a radio link failure based at least in part on transmitting the information identifying the one or more adjusted measurement values.

27. The non-transitory computer-readable medium of claim 19, wherein the one or more adjusted measurement values apply to at least one of a serving cell or a neighbor cell.

28. An apparatus for wireless communication, comprising:
means for determining that one or more threshold criteria are satisfied, wherein the one or more threshold criteria include at least one of a first value for an uplink grant rate, a second value for a buffer size, or a third value for a packet data convergence protocol discard rate, wherein the one or more threshold criteria relate to a network condition with less than a reference uplink throughput and greater than a reference downlink throughput; and
means for transmitting information identifying one or more adjusted measurement values based at least in part on the determination of the one or more threshold criteria.

29. The apparatus of claim 28, further comprising:
means for determining, based at least in part on one or more values associated with the one or more threshold criteria, a power headroom; and
wherein the means for transmitting the information identifying the one or more adjusted measurement values comprises:
means for transmitting the information identifying the one or more adjusted measurement values based at least in part on the power headroom.

30. The apparatus of claim 28, wherein the one or more threshold criteria are satisfied for a threshold period of time; and
wherein the means for transmitting the information identifying the one or more adjusted measurement values comprises:
means for transmitting the information identifying the one or more adjusted measurement values based at least in part on the one or more threshold criteria being satisfied for the threshold period of time.

31-37. (canceled)
